(19) United States
(12) Patent Application Publication
(10) Pub. No.: US 2011/0235765 A1
(43) Pub. Date: Sep. 29, 2011

(54) Man made silver

(76) Inventor: Kuai-Teng Hsu, Clarksville, MD (US)

(21) Appl. No.: 12/009,156

(22) Filed: Jan. 17, 2008

(51) Int. Cl. G21G 1/00

(52) U.S. Cl. 376/108

(57) ABSTRACT

A man made method, utilizing particles bombardment technique, is used to produce Silver. The particles bombardment technique uses particle accelerator to accelerate Boron particles to high speed. These high speed Boron particles contain high energy. These high energy Boron particles are used to bombard Molybdenum elements. Then elements Boron and Molybdenum undergo cold fusion process that they are combined to produce Silver.

### BACKGROUND OF THE PRESENT INVENTION

1. Field of Invention

The present invention relates to a method, and more particularly a man made method to produce silver.

2. Description of Related Arts

### Silver

### History

Silver has been known since ancient times. It is mentioned in Genesis. Slag dumps in Asia Minor and on islands in the Aegean Sea indicate that man learned to separate silver from lead as early as 3000 B.C.

### Sources

Silver occurs native and in ores such as argentite (Ag₂S) and horn silver (AgCl). Also, lead, lead-zinc, copper, gold, and copper-nickel ores are principal sources. Mexico, Canada, Peru, and the U.S. are the principal silver producers in the western hemisphere.

### Production

Silver can be recovered during electrolytic refining of copper. Commercial fine silver contains at least 99.9% silver. Purities of 99.999+% are available commercially.

### Properties

Pure silver has a brilliant white metallic luster. It is a little harder than gold and is very ductile and malleable, being exceeded only by gold and perhaps palladium. Pure silver has the highest electrical and thermal conductivity of all metals, and possesses the lowest contact resistance. It is stable in pure air and water, but tarnishes when exposed to ozone, hydrogen sulfide, or air containing sulfur.

### Uses

Sterling silver is used for jewelry, silverware, etc. where appearance is paramount. This alloy contains 92.5% silver, the remainder being copper or some other metal. Silver is of the utmost importance in photography, about 30% of the U.S. industrial consumption going into this application. It is used for dental alloys. Silver is used in making solder and brazing alloys, electrical contacts, and high capacity silver-zinc and silver-cadmium batteries. Silver paints are used for making printed circuits. It is used in mirror production and may be deposited on glass or metals by chemical deposition, electrode position, or by evaporation. When freshly deposited, it is the best reflector of visible light known, but is rapidly tarnished and loses much of its reflectance. It is a poor reflector of ultraviolet. Silver fulminate, a powerful explosive, is sometimes formed during the silvering process. Silver iodide is used in seeding clouds to produce rain. Silver chloride has interesting optical properties as it can be made transparent; it also is a cement for glass. Silver nitrate, or lunar caustic, the most important silver compound, is used extensively in photography. For centuries silver has been used traditionally for coinage by many countries of the world. In recent times, however, consumption of silver has greatly exceeded the output.

### Handling

While silver itself is not considered to be toxic, most of its salts are poisonous. Silver compounds can be absorbed in the circulatory system and reduced silver deposited in the various tissues of the body. A condition, known as argyria, results with a grayish pigmentation of the skin and mucous membranes. Silver has germicidal effects and kills many lower organisms effectively without harm to higher animals.

### Cost

In 1939, the price of silver was fixed by the U.S. Treasury at 71 cents/troy oz., and at 90.5 cents/troy oz. in 1946. In November 1961 the U.S. Treasury suspended sales of nonmonetized silver, and the price stabilized for a time at about $1.29, the melt-down value of silver U.S. coins. The coinage act of 1965 authorized a change in the metallic composition of the three U.S. subsidiary denominations to clad or composite type coins. This was the first change in U.S. coinage since the monetary system was established in 1792. Silver coins of other countries have largely been replaced with coins made of other metals. On Jun. 24, 1968, the U.S. Government ceased to redeem U.S. Silver Certificates with silver. Since that time, the price of silver has fluctuated widely. As of January 1990, the price of silver was about $5.25/troy oz.; however, the price has fluctuated considerably due to market instability.

### Particle Accelerator

A particle accelerator is a device that uses electric fields to propel electrically charged particles to high speed. These high speed particles contain high energy.

### Particle Bombardment Technique

Particles accelerated by particle accelerator to high energy can be used to bombard target elements for conducting experiments. This is called particle bombardment technique.

### Nuclear Fusion

Nuclear fusion is the process by which multiple nuclei join together to form a heavier nucleus. It is accompanied by the release or absorption of energy depending on the masses of the nuclei involved.

### Cold Fusion

Cold fusion is a nuclear fusion process that occurs at normal temperature.

### SUMMARY OF THE PRESENT INVENTION

The main object of the present invention is to provide a man made method to produce silver, which has high market value.

Another object of the present invention is to man made silver by using particle bombardment technique.

Another object of the present invention is to man made silver by utilizing particle accelerator to accelerate Boron particles to high speed. These high speed Boron particles contain high energy. Then let these high energy Boron particles to bombard Molybdenum element. Then elements Boron and Molybdenum undergo cold fusion process that they are combined to produce silver.

### BRIEF DESCRIPTION OF THE DRAWING

None

### DETAILED DESCRIPTION OF THE PREFERRED EMBODIMENT

It was proved by experiment and reported in publication that, by utilizing particle bombardment technique, we can use particle accelerator to accelerate the particles of element Chromium (atomic symbol Cr) to high speed. These high speed Chromium particles contain high energy. Then let these high energy Chromium particles to bombard the element Bismuth (atomic symbol Bi). Then elements Chromium and Bismuth undergo cold fusion process that they are combined to produce the element Bohrium (atomic symbol Bh) and one neutron (atomic symbol n).

In equation, it is described as:

Cr+Bi→Bh+n (1)

The total atomic number on both sides of equation (1) are balanced as:

| | |
|---|---|
| element | atomic number |

atomic number on the left side of equation (1)

| | |
|---|---|
| Cr | 24 |
| Bi | 83 |
| Total atomic number on left side is | 107 |

atomic number on right side of equation (1)

| | |
|---|---|
| Bh | 107 |
| Neutron | 0 |
| Total atomic number on right side is | 107 |

So, both sides of the equation (1) have total atomic number 107.

Also, total atomic mass on both sides of equation (1) are balanced as:

| | |
|---|---|
| element | atomic mass |

atomic mass on left side of equation (1)

| | |
|---|---|
| Cr | 54 |
| Bi | 209 |
| Total atomic mass on left side is | 263 |

atomic mass on right side of equation (1)

| | |
|---|---|
| Bh | 262 |
| Neutron | 1 |
| Total atomic mass on right side is | 263 |

So, both sides of equation (1) have atomic mass 263.

Using the same theory and technique, we can use particle accelerator to accelerate the particle of element Boron (atomic symbol B) to high speed. These high speed Boron particles contain high energy. Then let these high energy Boron particles to bombard the element Molybdenum (atomic symbol Mo). Then elements Boron and Molybdenum undergo cold fusion process that they are combined to produce Silver (atomic symbol Ag).

In equation, it is described as:

B+Mo→Ag (2)

The total atomic number on both sides of equation (2) are balanced as:

| | |
|---|---|
| element | atomic number |

atomic number on the left side of equation (2)

| | |
|---|---|
| B | 5 |
| Mo | 42 |
| Total atomic number on left side is | 47 |

atomic number on right side of equation (2)

| | |
|---|---|
| Ag | 47 |
| Total atomic number on right side is | 47 |

So, both sides of equation (2) have atomic number 47.

Also, the atomic mass on both sides of equation (2) are balanced as:

| | |
|---|---|
| element | atomic mass |

atomic mass on left side of equation (2)

| | |
|---|---|
| B | 11 |
| Mo | 96 |
| Total atomic mass on left side is | 107 |

atomic mass on right side of equation (2)

| | |
|---|---|
| Ag | 107 |
| Total atomic mass on right side is | 107 |

So, both sides of the equation (2) have atomic mass 107.

This proves the equation (2) is valid.

What is claimed is:

1. A man made method to produce Silver by cold fusion process between Boron and Molybdenum elements, comprising the following steps:
a. This method uses element particle bombardment technique.
b. This bombardment technique uses particle accelerator.
c. Boron particles are accelerated by particle accelerator to high speed.
d. These high speed Boron particles contain high energy.
e. These high energy Boron particles are used to bombard target Molybdenum elements.
f. Then, elements Boron and Molybdenum undergo cold fusion process that they are combined to produce Silver.
